(19) United States
(12) Patent Application Publication
(10) Pub. No.: US 2017/0340050 A1
(43) Pub. Date: Nov. 30, 2017

(54) BICYCLE PEDAL COVER SYSTEMS

(71) Applicants: Jarrett Vaughan, Vancouver (CA); Luke Brian Armstrong, Chilliwack (CA)

(72) Inventors: Jarrett Vaughan, Vancouver (CA); Luke Brian Armstrong, Chilliwack (CA)

(21) Appl. No.: 15/167,632

(22) Filed: May 27, 2016

(51) Int. Cl. A43B 3/20; A43B 7/08; B62M 3/16; B62M 3/08

(52) U.S. Cl. CPC A43B 3/20; B62M 3/16; A43B 7/085; B62M 3/08

(57) ABSTRACT

A bicycle pedal cover system for covering and protecting footwear from inclement weather, mostly rain. The water proof device simply clips on to the cycle pedals, covering the footwear and protecting the shoe from getting wet while cycling. The device is slightly larger than the footwear and allows the foot of a user to be easily inserted without impeding any movement whatsoever. Further, the device is able to collapse into a flat object and be mounted to a seat post of a bike for convenient storage and portability.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of bicycle accessories and more specifically relates to a bicycle pedal cover system.

### 2. DESCRIPTION OF RELATED ART

Cycling, also called bicycling or biking, is the use of bicycles for transport, recreation, exercise or sport. Persons engaged in cycling are referred to as “cyclists”, “bikers”, or less commonly, as “bicyclists”. Apart from two-wheeled bicycles, “cycling” also includes the riding of unicycles, tricycles, quadracycles, recumbent and similar human-powered vehicles. Bicycles are the principal means of transportation in many parts of the world. Cycling is widely regarded as a very effective and efficient mode of transportation optimal for short to moderate distances.

Bicycles provide numerous benefits in comparison with motor vehicles, including the sustained physical exercise involved in cycling, easier parking, increased maneuverability, and access to both roads, bike paths and rural trails. Cycling also offers a reduced consumption of fossil fuels, less air or noise pollution, much reduced traffic congestion. These lead to less financial cost to the user as well as to society at large (negligible damage to roads, less road area required, but a many cyclists clustering at peak times create a CO₂ issue when exhaling). By fitting bicycle racks on the front of buses, transit agencies can significantly increase the areas they can serve.

Among the disadvantages of cycling are the requirement of bicycles to be balanced by the rider in order to remain upright, the reduced protection in crashes in comparison to motor vehicles, longer travel time (except in densely populated areas), and vulnerability to weather conditions. Weather conditions such as rain, can make cycling difficult and a cyclist's shoes and clothing may become wet. A suitable solution is desired.

Several attempts have been made to solve the above-mentioned problems such as those found in U.S. Pub. No. 2015/0342289 to Zhen Zhou Feng; 2012/0198595 to Tracy L. Young, U.S. Pat. No. 4,237,628 to Christian Etancelin; U.S. Pat. No. 8,745,900 to Richard M. Bryne; U.S. Pat. No. 4,836,047 to John M. Alcamo; U.S. Pat. No. 3,808,910 to Desbois R and Foreign Pat. Nos. EP 0106162 to Peter R. Prof. Dr. Cavanagh; CN 2188536 to Zhou Yan; and DE 2816189 to Dimokritos Reppas. This art is representative of bicycle accessories. However, none of the above inventions and patents, taken either singly or in combination, is seen to describe the invention as claimed.

Preferably, a bicycle pedal cover system should provide an efficient bicycle pedal cover for protection from rain and, yet would operate reliably and be manufactured at a modest expense. Thus, a need exists for a reliable bicycle pedal cover system to avoid the above-mentioned problems.

### BRIEF SUMMARY OF THE INVENTION

In view of the foregoing disadvantages inherent in the known bicycle accessory art, the present invention provides a novel bicycle pedal cover system. The general purpose of the present invention, which will be described subsequently in greater detail is to provide a bicycle pedal cover that protects shoe wear from inclement weather.

A bicycle pedal cover system is disclosed herein preferably comprising at least one collapsible bicycle pedal cover assembly each at least one collapsible bicycle pedal cover assembly having a foot insert member, a first flange, a second flange, a third flange, and universal fastening members. As such, the bicycle pedal cover system comprises the at least one collapsible bicycle pedal cover assembly. The at least one collapsible bicycle pedal cover assembly comprises the foot insert member, the first flange, the second flange, the third flange, and the universal fastening members in functional combination. Various contours may be used. The universal fastening members connect the at least one collapsible bicycle pedal cover assembly to a pedal of a bicycle. The universal fastening members may comprise bolts or other suitably equivalent fastening means. Fastening means may allow for quick release for convenience. A user may remove the bicycle pedal cover system when weather is suitable.

The bicycle pedal cover assembly comprises a pedal socket for fastening the at least one collapsible bicycle pedal cover assembly to the pedal of the bicycle. The foot insert member houses a foot (and footwear) of a user. The foot insert member comprises a small metal piece located at a front of a pedal connection point providing weight allowing the foot insert member to tip forward rather than upside down allowing easy insertion of the foot of the user. The foot insert member comprises a body that is larger than the footwear worn on the foot of the user such that it is offset and the body partially envelopes the footwear.

An outside surface of the shoe of the user occupies a position adjacent to the inner volume of the foot insert member when used. A heel of the footwear worn on the foot of the user is exposed outside the at least one collapsible bicycle pedal cover assembly. At least one collapsible bicycle pedal cover assembly preferably comprises a smooth water resistant and aerodynamic body. At least one collapsible bicycle pedal cover assembly comprises light-weight material and are offered as a pair of the at least one bicycle pedal cover assemblies comprising a left and a right. The bicycle pedal cover assembly comprises weather resistant plastic or soft rubber for durability. The foot insert member comprises a drain hole for allowing the water to exit the foot insert member and thereby preventing the water from pooling. The drain hole is located near a lower toe point of the foot insert member. The drain hole further provides ventilation.

The first flange, the second flange, and the third flange are integrally formed to contour to footwear, when worn, being worn on the foot of the user. The first flange and the third flange protect the foot of the user and a shoe of the user preventing water from hitting the sides of the foot of the user. The first flange and the third flange extend outwardly along adjacent sides of the footwear worn on the foot of the user to protect and block the (front of) footwear worn on the foot of the user. The third flange contours to a lower shin portion of the leg of the user. The second flange protects a leg of the user from the water hitting a front of the leg of the user. The second flange acts as a front deflector for protecting the leg of the user. The bicycle pedal cover assembly is useful for protecting the foot and the leg of the user while riding the bicycle in various weather conditions.

A kit is described herein including: at least one collapsible bicycle pedal cover assembly (right and left), and a set of user instructions for mounting to a pedal of the bicycle.

A method of using a bicycle pedal cover system is also disclosed herein comprising the steps of: mounting at least one collapsible bicycle pedal cover assembly to a pedal of a bicycle, inserting a shoe of a user into a foot insert member of the at least one collapsible bicycle pedal cover assembly, riding a bicycle, and removing the at least one collapsible bicycle pedal cover assembly from the pedal of the bicycle.

The present invention holds significant improvements and serves as a bicycle pedal cover system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bicycle pedal cover systems, constructed and operative according to the teachings of the present invention.

FIG. 1 shows a perspective view illustrating a bicycle pedal cover system during an ‘in-use’ condition showing a foot of a user positioned within a foot insert member according to an embodiment of the present invention.

FIG. 2 is a perspective view illustrating the bicycle pedal cover system comprising a bicycle pedal cover assembly according to an embodiment of the present invention of FIG. 1.

FIG. 3 is a perspective view illustrating the bicycle pedal cover assembly according to an embodiment of the present invention of FIGS. 1-2.

FIG. 4 is a perspective view illustrating the bicycle pedal cover assembly according to an embodiment of the present invention of FIGS. 1-3.

FIG. 5 is a flowchart illustrating a method of use for bicycle pedal cover systems according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a bicycle pedal cover that protects footwear and more particularly to a bicycle pedal cover system as used to improve the protection and support of a foot and footwear of a cyclist.

Generally speaking, the bicycle pedal cover protects shoes from wear from inclement weather such as rain. The water proof device simply attaches on to the cycle pedals, covering the shoe and protects the shoe from getting wet while cycling to or from work and the like. The device is slightly larger than the shoe (offset from) and allows the foot/shoe to be easily inserted without impeding any movement. The bicycle pedal cover may be collapsible. Once the device has been made flat, it may be mounted to the bicycle seat post or cross bar for storage during non-use. Certain embodiments may comprise a quick release mounting system such as pins or other suitable fastening means.

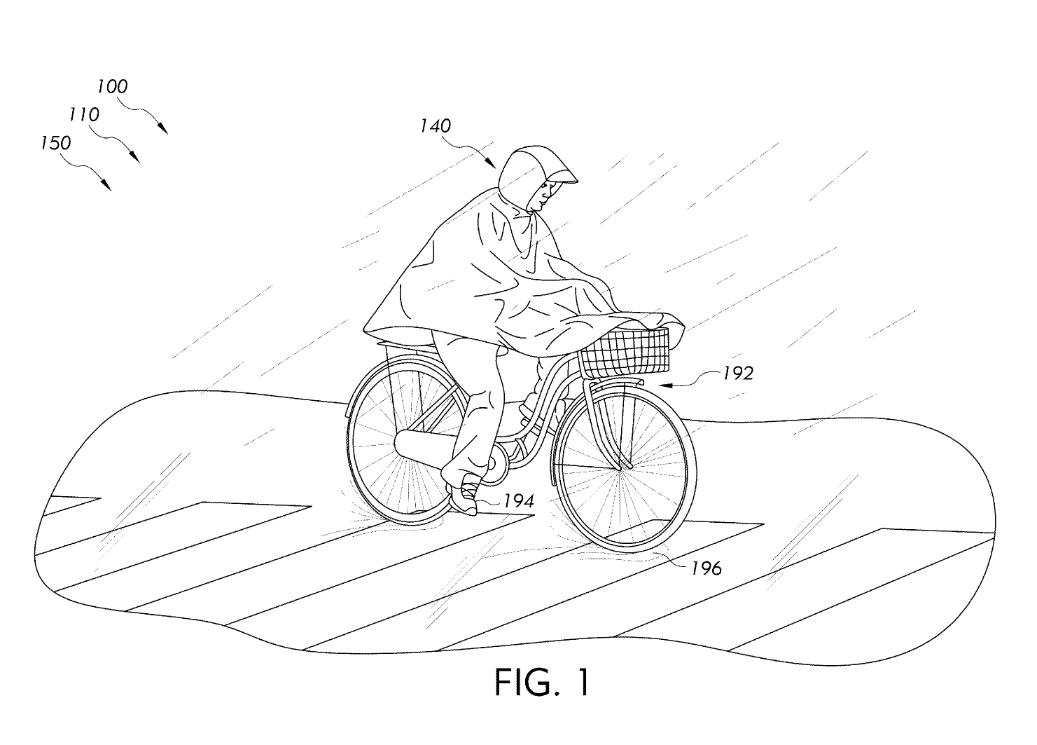

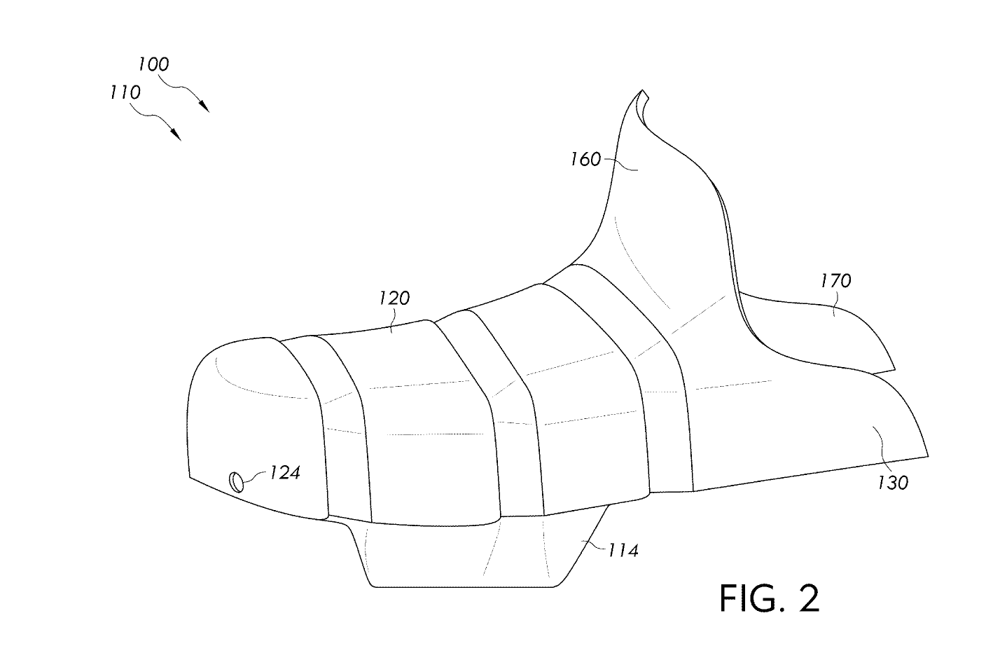

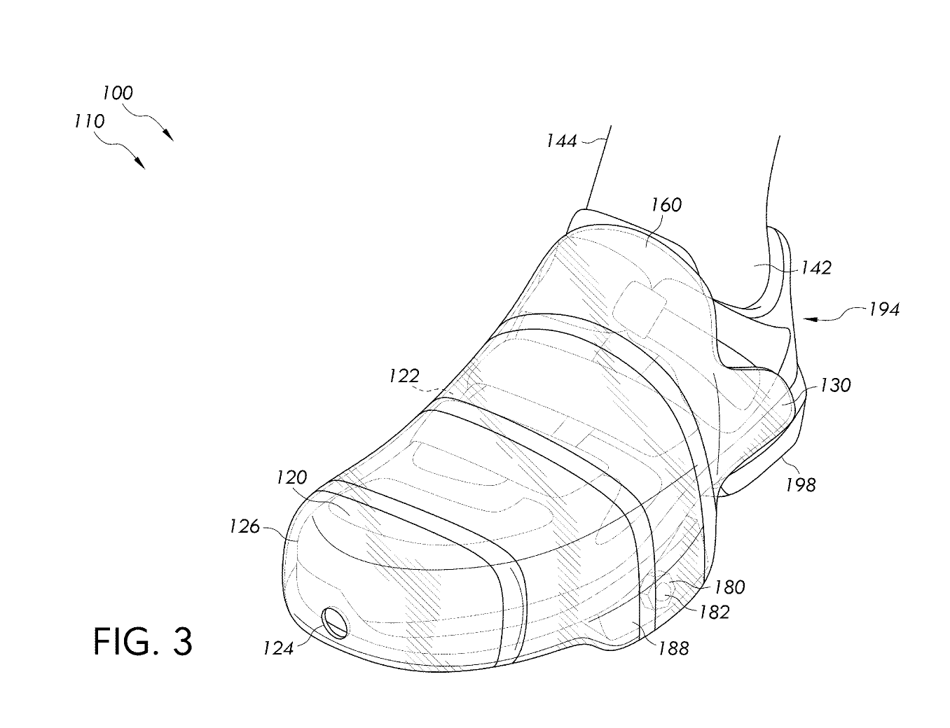

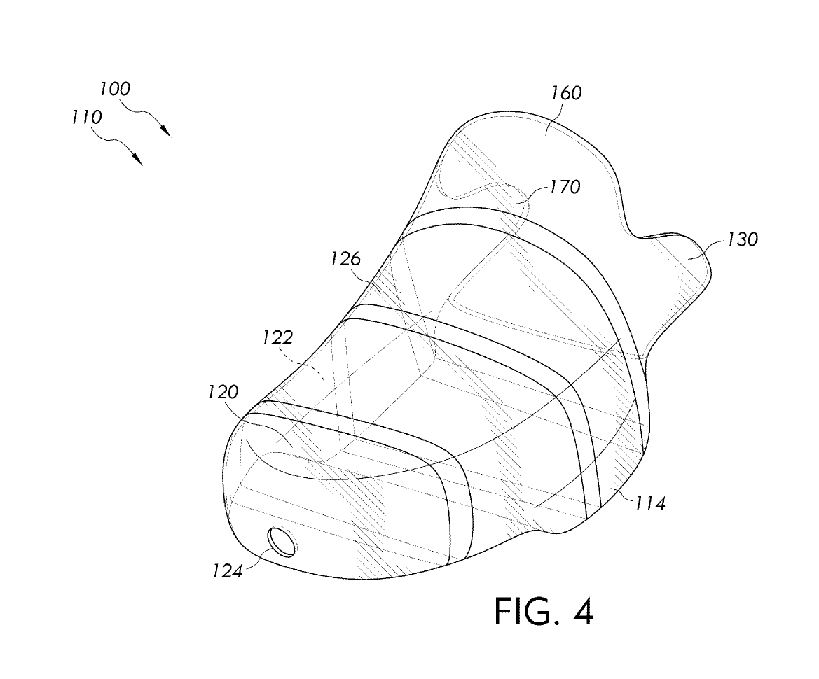

Referring to the drawings by numerals of reference there is shown in FIGS. 1-4, various views of bicycle pedal cover system 100 comprising: at least one collapsible bicycle pedal cover assembly 110 each at least one collapsible bicycle pedal cover assembly 110 having foot insert member 120, first flange 130, second flange 160, third flange 170, and universal fastening members 180. Bicycle pedal cover system 100 comprises at least one collapsible bicycle pedal cover assembly 110. At least one collapsible bicycle pedal cover assembly 110 comprises foot insert member 120, first flange 130, second flange 160, third flange 170, and universal fastening members 180 in functional combination. Universal fastening members 180 connect at least one collapsible bicycle pedal cover assembly 110 to pedal 188 of bicycle 192. Foot insert member 120 houses foot 142 of user 140.

First flange 130, second flange 160, and third flange 170 are integrally formed to contour to footwear 194, when worn, being worn on foot 142 of user 140. First flange 130 and third flange 170 protect foot 142 of user 140 and footwear 194 of user 140 from water 196 hitting sides of foot 142 of user 140. Second flange 160 protects leg 144 of user 140 from water 196 hitting front of leg 144 of user 140. Bicycle pedal cover assembly 110 is useful for protecting foot 142 and leg 144 of user 140 while riding bicycle 192 in various weather conditions. At least one collapsible bicycle pedal cover assembly 110 comprises a smooth water resistant and aerodynamic body. Universal fastening members 180 comprise bolts 182. Foot insert member 120 comprises a small metal piece located at a front of a pedal connection point providing weight allowing foot insert member 120 to tip forward rather than upside down allowing easy insertion of foot 142 of user 142.

Foot insert member 120 comprises drain hole 124 for allowing water 196 to exit foot insert member 120 and preventing water 196 from pooling. Drain hole 124 is located near lower toe point of foot insert member 120. Second flange 160 acts as a front deflector for protecting leg 144 of user 140. Bicycle pedal cover assembly 110 comprises pedal socket 114 for fastening at least one collapsible bicycle pedal cover assembly 110 to pedal 188 of bicycle 192. Third flange 170 contours to lower shin portion of leg 144 of user 140. Foot insert member 120 comprises body 126 that is larger than footwear 194 worn on foot 142 of user 140 such that it is offset and body 126 partially envelopes footwear 194.

Outside surface of footwear 194 of user 140 occupies a position adjacent to inner volume 122 of foot insert member 120. At least one collapsible bicycle pedal cover assembly 110 comprises light-weight material and are offered as a pair of at least one bicycle pedal cover assemblies 110 comprising a left and a right. Bicycle pedal cover assembly 110 may comprise weather resistant plastic or other such suitable material. Heel 198 of footwear 194 worn on foot 142 of user 140 is exposed outside at least one collapsible bicycle pedal cover assembly 110. Drain hole 124 provides ventilation. First flange 130 and third flange 170 extend outwardly along adjacent sides of footwear 194 worn on foot 142 of user 140 to protect and block footwear 194 worn on foot 142 of user 140.

Bicycle pedal cover system 100 may be sold as kit 440 comprising the following parts: at least one collapsible bicycle pedal cover assembly; and at least one set of user instructions. The kit has instructions such that functional relationships are detailed in relation to the structure of the invention (such that the invention can be used, maintained, or the like in a preferred manner). Bicycle pedal cover system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different contour combinations, parts may be sold separately, etc., may be sufficient.

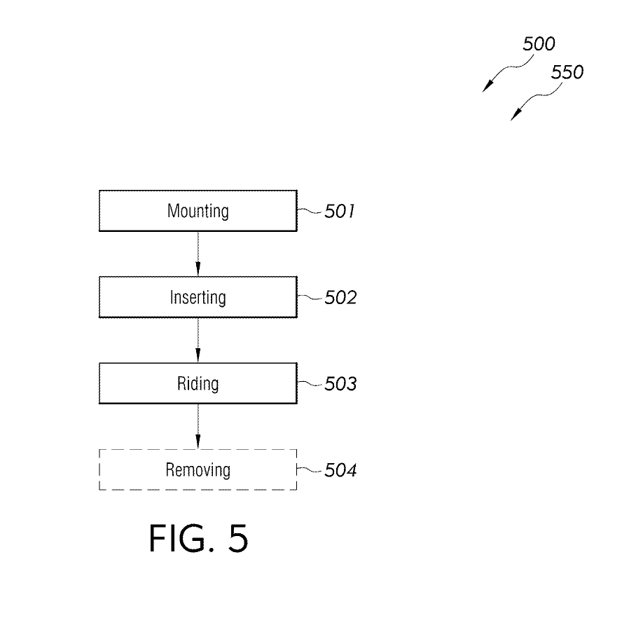

Referring now to FIG. 5 showing flowchart 550 illustrating method of use 500 for bicycle pedal cover systems 100 according to an embodiment of the present invention of FIGS. 1-4. As shown, method of use 500 may comprise the steps of: step one 501, mounting at least one collapsible bicycle pedal cover assembly 110 to pedal 188 of bicycle 192; step two 502 inserting footwear 194 of user 140 into foot insert member 120 of at least one collapsible bicycle pedal cover assembly 110; step three 503 riding bicycle 192; and step four 504 removing at least one collapsible bicycle pedal cover assembly 110 from pedal 188 of bicycle 192.

It should be noted that step four 504 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bicycle pedal cover system comprising:
at least one collapsible bicycle pedal cover assembly each said at least one collapsible bicycle pedal cover assembly having;
a foot insert member;
a first flange;
a second flange;
a third flange; and
universal fastening members;
wherein said bicycle pedal cover system comprises said at least one collapsible bicycle pedal cover assembly;
wherein said at least one collapsible bicycle pedal cover assembly comprises said foot insert member, said first flange, said second flange, said third flange, and said universal fastening members in functional combination;
wherein said universal fastening members connect said at least one collapsible bicycle pedal cover assembly to a pedal of a bicycle;
wherein said foot insert member houses a foot of a user;
wherein said first flange, said second flange, and said third flange are integrally formed to contour to footwear, when worn, being worn on said foot of said user;
wherein said first flange and said third flange protect said foot of said user and a shoe of said user from said water hitting sides of said foot of said user;
wherein said second flange protects a leg of said user from said water hitting a front of said leg of said user; and
wherein said bicycle pedal cover assembly is useful for protecting said foot and said leg of said user while riding said bicycle in various weather conditions.

2. The bicycle pedal cover system of claim 1 wherein said at least one collapsible bicycle pedal cover assembly comprises a smooth water resistant and aerodynamic body.

3. The bicycle pedal cover system of claim 1 wherein said universal fastening members comprise bolts.

4. The bicycle pedal cover system of claim 1 wherein said foot insert member comprises a small metal piece located at a front of a pedal connection point providing weight allowing said foot insert member to tip forward rather than upside down allowing easy insertion of said foot of said user.

5. The bicycle pedal cover system of claim 4 wherein said foot insert member comprises a drain hole for allowing said water to exit said foot insert member and preventing said water from pooling.

6. The bicycle pedal cover system of claim 1 wherein said drain hole is located near a lower toe point of said foot insert member.

7. The bicycle pedal cover system of claim 1 wherein said second flange acts as a front deflector for protecting said leg of said user.

8. The bicycle pedal cover system of claim 1 wherein said bicycle pedal cover assembly comprises a pedal socket for fastening said at least one collapsible bicycle pedal cover assembly to said pedal of said bicycle.

9. The bicycle pedal cover system of claim 1 wherein said third flange contours to a lower shin portion of said leg of said user.

10. The bicycle pedal cover system of claim 1 wherein said foot insert member comprises a body that is larger than said footwear worn on said foot of said user such that it is offset and said body partially envelopes said footwear.

11. The bicycle pedal cover system of claim 1 wherein an outside surface of said shoe of said user occupies a position adjacent to said inner volume of said foot insert member.

12. The bicycle pedal cover system of claim 1 wherein said at least one collapsible bicycle pedal cover assembly comprises light-weight material and are offered as a pair of said at least one bicycle pedal cover assemblies comprising a left and a right.

13. The bicycle pedal cover system of claim 1 wherein said bicycle pedal cover assembly comprises weather resistant plastic.

14. The bicycle pedal cover system of claim 1 wherein said a heel of said footwear worn on said foot of said user is exposed outside said at least one collapsible bicycle pedal cover assembly.

15. The bicycle pedal cover system of claim 5 wherein said drain hole provides ventilation.

16. The bicycle pedal cover system of claim 1 wherein said first flange and said third flange extend outwardly along adjacent sides of said footwear worn on said foot of said user to protect and block said footwear worn on said foot of said user.

17. A bicycle pedal cover system comprising:
at least one collapsible bicycle pedal cover assembly each said at least one collapsible bicycle pedal cover assembly having;
a foot insert member;
a first flange;
a second flange;
a third flange; and
universal fastening members;
wherein said bicycle pedal cover system comprises said at least one collapsible bicycle pedal cover assembly;
wherein said at least one collapsible bicycle pedal cover assembly comprises said foot insert member, said first flange, said second flange, said third flange, and said universal fastening members in functional combination;
wherein said universal fastening members connect said at least one collapsible bicycle pedal cover assembly to a pedal of a bicycle;
wherein said universal fastening members comprise bolts;
wherein said bicycle pedal cover assembly comprises a pedal socket for fastening said at least one collapsible bicycle pedal cover assembly to said pedal of said bicycle;
wherein said foot insert member houses a foot of a user;
wherein foot insert member comprises a small metal piece located at a front of a pedal connection point providing weight allowing said foot insert member to tip forward rather than upside down allowing easy insertion of said foot of said user;
wherein said foot insert member comprises a body that is larger than said footwear worn on said foot of said user such that it is offset and said body partially envelopes said footwear;
wherein an outside surface of said shoe of said user occupies a position adjacent to said inner volume of said foot insert member;
wherein said a heel of said footwear worn on said foot of said user is exposed outside said at least one collapsible bicycle pedal cover assembly;
wherein said at least one collapsible bicycle pedal cover assembly comprises a smooth water resistant and aerodynamic body;
wherein said at least one collapsible bicycle pedal cover assembly comprises light-weight material and are offered as a pair of said at least one bicycle pedal cover assemblies comprising a left and a right;
wherein said bicycle pedal cover assembly comprises weather resistant plastic;
wherein said foot insert member comprises a drain hole for allowing said water to exit said foot insert member and preventing said water from pooling;
wherein said drain hole is located near a lower toe point of said foot insert member;
wherein said drain hole provides ventilation;
wherein said first flange, said second flange, and said third flange are integrally formed to contour to footwear, when worn, being worn on said foot of said user;
wherein said first flange and said third flange protect said foot of said user and a shoe of said user from said water hitting sides of said foot of said user;
wherein said first flange and said third flange extend outwardly along adjacent sides of said footwear worn on said foot of said user to protect and block said footwear worn on said foot of said user;
wherein said third flange contours to a lower shin portion of said leg of said user;
wherein said second flange protects a leg of said user from said water hitting a front of said leg of said user;
wherein said second flange acts as a front deflector for protecting said leg of said user;
wherein said bicycle pedal cover assembly is useful for protecting said foot and said leg of said user while riding said bicycle in various weather conditions.

18. The bicycle pedal cover system of claim 17 further comprising a kit including:
said at least one collapsible bicycle pedal cover assembly; and
a set of user instructions for mounting said at least one collapsible bicycle pedal cover assembly using a universal quick release mounting means to said pedal of said bicycle.

19. A method of using a bicycle pedal cover system comprising the steps of:
mounting at least one collapsible bicycle pedal cover assembly to a pedal of a bicycle;
inserting a shoe of a user into a foot insert member of said at least one collapsible bicycle pedal cover assembly; and
riding a bicycle.

20. The method of claim 19 further comprising the steps of:
removing said at least one collapsible bicycle pedal cover assembly from said pedal of said bicycle.
